(19) United States
(12) Patent Application Publication
(10) Pub. No.: US 2016/0014609 A1
(43) Pub. Date: Jan. 14, 2016

(54) RANGE CONFIGURABLE BEACON BASED DEVICES FOR SMART INTERACTION AND BROADCAST OF INFORMATION

(71) Applicant: Altierre Corporation, San Jose, CA (US)

(72) Inventors: Anurag Goel, San Jose, CA (US); Sunit Saxena, San Jose, CA (US)

(21) Appl. No.: 14/795,739

(22) Filed: Jul. 9, 2015

Related U.S. Application Data
(60) Provisional application No. 62/022,612, filed on Jul. 9, 2014.

(51) Int. Cl. H04W 16/00; H04W 72/00; H04W 76/02; H04W 72/04

(52) U.S. Cl. CPC H04W 16/00; H04W 72/042; H04W 72/005; H04W 72/0446; H04W 76/021

(57) ABSTRACT

A beacon system and method are provided. The system provides schemes and methods whereby range configurable beacons can smartly choose to either broadcast information in their vicinity or allow another device to interact with it at the user's discretion. In some incarnations, a Mobile or Smart Phone devices could deduce information meaningful in context of the applications running on the Mobile or Smart Phone devices, from such beacon based devices with configurable range allowing options for either beacon device operation or user initiated interaction with the beacon device.

### PRIORITY CLAIMS/RELATED APPLICATIONS

This application claims the benefit under 35 USC 119(e) to and claims priority under 35 USC 120 to U.S. Provisional Patent Application Ser. No. 62/022,612 filed on Jul. 9, 2014 and entitled “Range Configurable Beacon Based Devices for Smart Interaction and Broadcast of Information”, the entirety of which is incorporated herein by reference.

### FIELD

The disclosure relates generally to range configurable beacons and in particular to a system that uses range configurable beacons to choose whether to broadcast information and what information to broadcast in their vicinity.

### BACKGROUND

Location information is commonly used by mobile apps for various purposes. The location can be absolute as in latitude/longitude or it can be a named location. Many mobile devices like Mobile Phones and Smart Phones, etc. (referred to hereafter as Mobile Devices) today commonly have GPS capabilities built into them allowing those devices to locate and use their coordinates such as in terms of the standard latitude/longitude pair. However, the GPS functionality may not work in indoor locations or may not differentiate multi-story locations at the same latitude/longitude, and thus the location needs to be discovered using alternate means. Certain applications may also call for contextual or named location determination using means other than GPS locationing regardless of whether client device is indoors or outdoors. Contextual location can be labeled, broadcasted and discovered with the use of short-range radio beacons which can be read by bringing a Mobile Device very close to the beacon. An additional consideration is that not all Mobile Devices are equipped with short-range beacon readers and can only read long range beacons which makes labeling of locations meant to be read at short ranges only, extremely imprecise as other long range beacon transmissions would impinge on the beacon intended to be read.

### BRIEF DESCRIPTION OF THE DRAWINGS

FIG. 1 illustrates an example of a structure, such as a retail store, that may utilize range configurable beacons;

FIG. 2 illustrates an example of a range configurable beacon system; and

FIG. 3 illustrates more details of the range configurable beacon system.

### DETAILED DESCRIPTION OF ONE OR MORE EMBODIMENTS

The disclosure is particularly applicable to a range configurable beacon system that may be used in a building and it is in this context that the disclosure will be described. It will be appreciated, however, that the system and method has greater utility since the range configurable beacon system may be used in other situations (yards, shipping docks, on top of transportation vehicles like ships and trucks, pipelines, factories, etc.), may be used indoors or outdoors and may be implemented in other manners that would be understood by one skilled in the art to be within the scope of the disclosure.

The range configurable beacon system and method provide methods for using devices containing beacons (referred to hereafter collectively as Beacons) to transmit information to other devices. This may also allow for extraction or deduction of absolute location information or named-location information. For named-location information to be precise and valid, the Beacons may be programmatically configured to have as short a range as called for by the application. The location information extracted may or may not be the Beacon's absolute location depending on how the application intends to use the information. The location information transmitted by the Beacons can be any relevant information for that application and may include location information or any other meaningful information that the interacting device can parse into contextual location meaningful to the applications.

Following are just a few examples of information that Beacons could be programmed to transmit:

1. Location information, Promotion or sale information, or inventory information or sensor information or combinations thereof, etc.

2. Geo-Coordinates transmitted as degrees/minutes/seconds: 40:26:46N 79:56:55W. Other formats for Geo-Coordinates may also be used.

3. Contextual Location transmitted as any other string meaningful to the applications running on the Client-Devices, for example: “Mom&PopStore#173, BigBoxStore#2737”, “RackID 32”, “Region 7” or simply the MAC ID of the Beacon, etc.

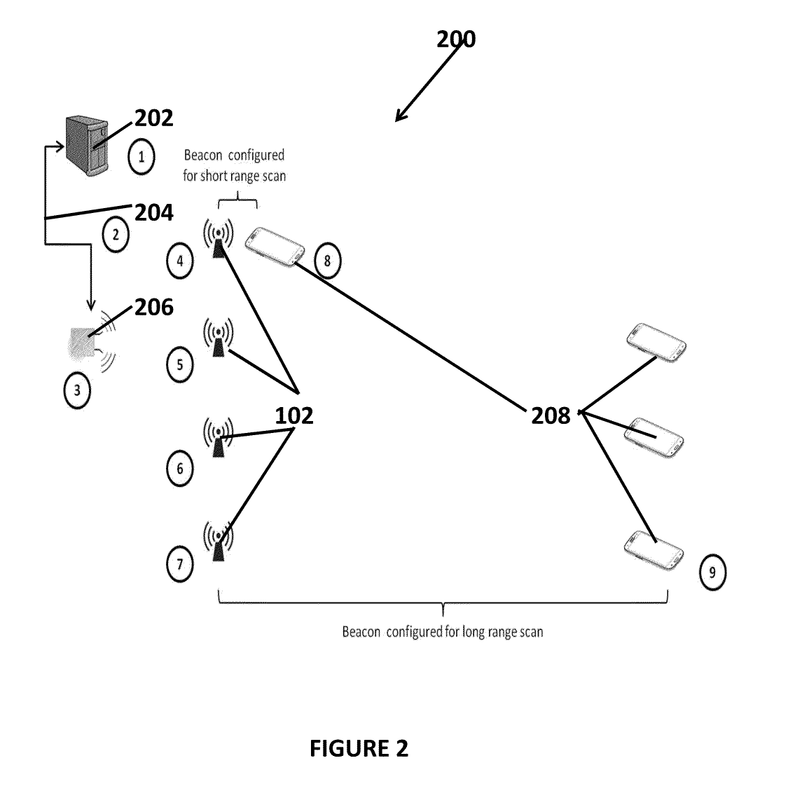

An example of a beacon system 200 is shown in FIG. 2 in which the system has one or more computers 202, such as one or more server computers in one implementation, a network 204 and an access point 206 that connect the computer 202 to a plurality of beacon devices 102 and allow the computer 202 and each of the beacon devices 102 to exchange data with each other. Each beacon device 102 may in turn communicate with one or more computing devices 208 as described above.

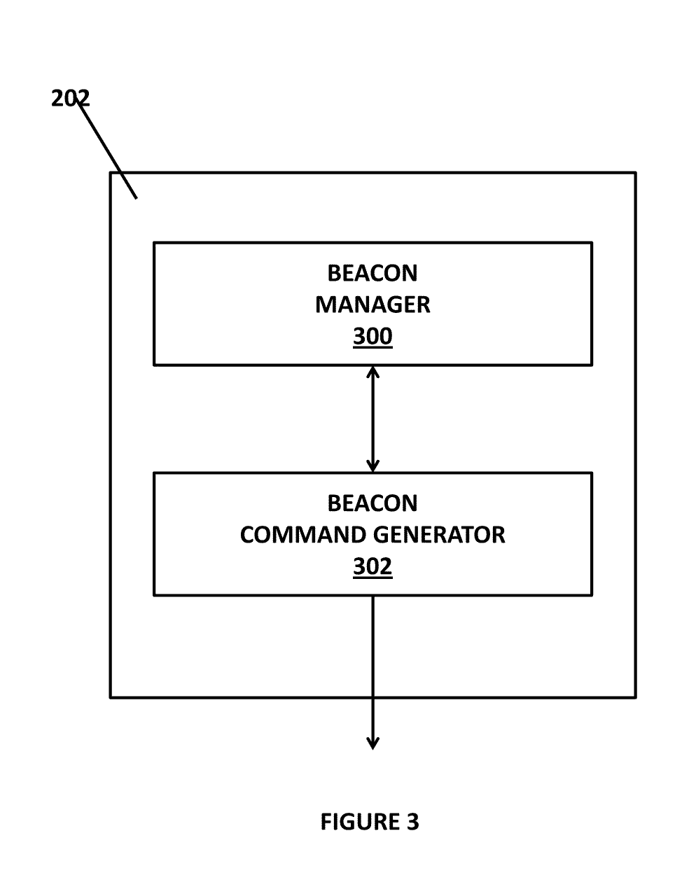

The one or more computers 202 may be a processor based device with memory, persistent storage and other computing resources that allow the one or more computers to control and configure each of the beacon devices 102. An example of an implementation of the computer 202 may be the server computer described above. As shown in FIG. 3, the computer 202 may further comprise a beacon manager 300 and a beacon command generator 302 that may perform the control, configuring and management of each of the beacon devices 102. Each of the beacon manager 300 and the beacon command generator 302 may be implemented in hardware or software. When either or both of the beacon manager 300 and the beacon command generator 302 may be implemented in software, the beacon manager 300 or the beacon command generator 302 may be a plurality of lines of computer code that may be executed by a processor of the computer 202. When the processor of the computer 202 executes the computer code, the processor is configured to perform the functions and operations of the beacon manager 300 or the beacon command generator 302. When either or both of the beacon manager 300 and the beacon command generator 302 may be implemented in hardware, the beacon manager 300 or the beacon command generator may be a hardware device or circuit, such as a programmable logic device, microcontroller, state machine and the like and the hardware device or circuit perform the functions and operations of the beacon manager 300 or the beacon command generator 302.

The network 204 may be a wired network or a wireless network or a combination of the two. The network may be a digital data network that uses a known protocol for communication between the computer 202 and the beacon devices 102. The access point 206 may be a typical wireless access point that converts the digital data signals of the computer 202 (communicated over the network 204) into wireless signals that may be communicated to each beacon device 102) and converts the wireless signals from each beacon device 102 into digital data signals that may be communicated to the computer 202.

Each beacon device 102 may be a processor based device that is able to operate as a beacon and periodically generate and transmit a beacon message to other devices. The beacon device may be Bluetooth Low Energy devices or Apple iBeacon devices, an NFC beacon device, an access point or other devices. The beacon devices 102 can communicate (send their beacon messages and/or communicate with the computer 202) via a variety of means including wireless, electromagnetic modulation, light, magnetic field interaction, heat and other forms of interaction that are within the scope of the disclosure. Each Beacon 102 can be standalone or imbedded in any device or fixture. For example in one implementation, beacons can be imbedded or be part of an electronic signage circuitry whereby the electronic signage can include a display of any type. The data and transmissions protocols of the data in a beacon message is known and any data and transmissions protocols of the data in a beacon message may be within the scope of the disclosure. The one or more computing devices 208 may each be a processor based device with memory, a display and input/output devices that is able to receive, process and respond to the beacon messages. For example, each computing device 208 may be a smartphone device such as an Apple® iPhone® device, an Android® operation system based device, a laptop device, a tablet device and the like. In the system 200, a processor of each computing device may execute an application that manages the interaction with the beacon devices 102.

The system 200 prescribes the discovery of nearby Beacons 102 interacting with other devices 208 including mobile devices like phones. This means that the application running on, or controlling the interacting device (an app) must be able to interpret the data it receives from the Beacon 102 by virtue of the app being aware a-priori of the meaning of the data it receives from the Beacon 102. The system may use information like, but not limited to, Beacon ID or Name to be, or contain the information, in any one of the chosen formats as described above. Thus, when a device 208 discovers a Beacon 102, it uses such information like the ID or Name of the Beacon to deduce the contextual or absolute location information. This allows any Beacon 102 to be discovered and read by an app running on the device 102 without requiring any pairing.

As an example, a wireless Access Point can be set up as a Beacon 102 where its SSID name space can be used entirely to signify the location information. An SSID is a user-definable name that identifies a particular wireless LAN. A Mobile Device 208 receives broadcast messages from all access points within range broadcasting their SSIDs. The SSID is defined to be several characters long, each of which may take any value. Following is an example of how in one implementation, the SSID name space can be segmented to provide unique location identification for the Beacon to transmit to the Mobile Devices:
1. LocationName: 6 octets
2. LocationID: 4 octets
3. SubLocation: 2 octets
4. Geo Coordinatess: 20 octets (written as DegreesMinutesSeconds with no spaces: dd:mm:ssNddd:mm:ssW)

In the above, an example of LocationName could be “MyStore”, LocationID could be “Store 47” and SubLocation could be “Department 9.”

In the system 200, the range of each Beacon 102 may be dynamically configured to be suitably long or short to provide the possibility of several Beacons coexisting in an enclosed space and uniquely identify their regions of coverage. For example, at deployment time, a beacon could be configured as a “CallOut” beacon that would be associated to a grouping of items such as on a rack and the beacon manager 300 would then program it for a suitably short range like 6 feet. Another beacon may be configured as an “Informational” beacon and the beacon manager 300 would program its range to be a short range, such as a few inches such that Mobile Device 208 would have to be brought close to beacon 102 in order to read beacon 102. “Informational” beacon carrying devices could be designated to display a message such as “Scan Me for more Information.” Another beacon could be configured as “LocationMarking” beacon and the beacon manager 300 could set its range to be as large as 0 feet-50 feet. The beacon manager 300 could also programmatically reconfigure one beacon type to another based on business rules. For example, an “Informational” beacon could become a “CallOut” beacon if the business requirement at some time changes from being informative to actively transmitting information to nearby Mobile Devices 208.

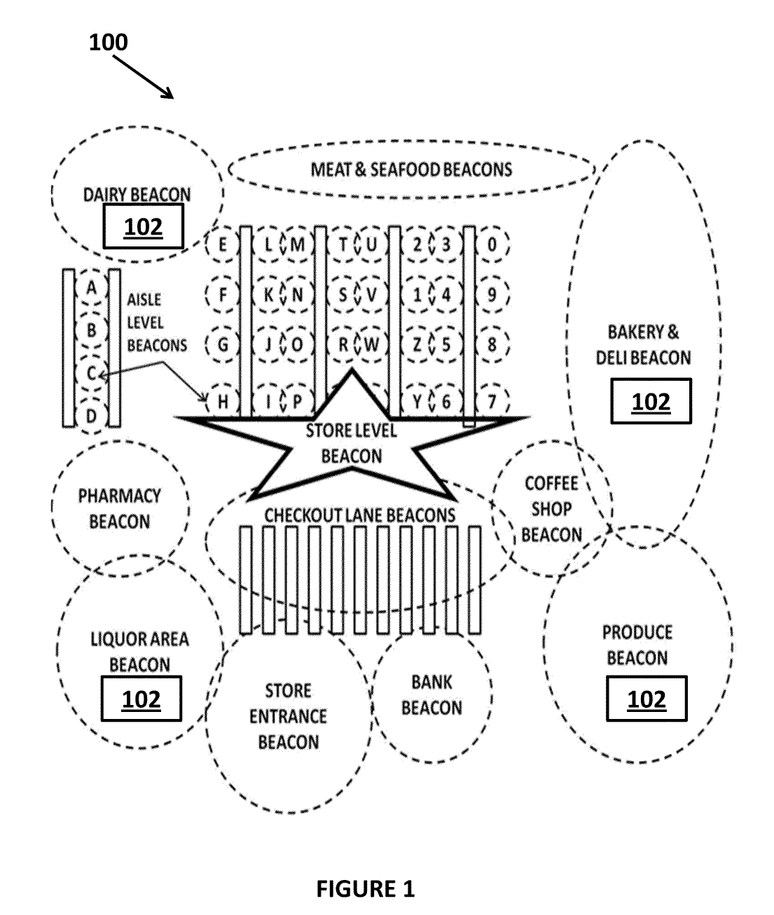

In the system, several beacons 102 may be needed in each section to identify local groups of products. If a device 208 enters a region with overlapping Beacon ranges, it may disambiguate its location based on the received signal strength of the signal received from the Beacons—or it may decide that it is within the range of all the overlapping Beacons. For example, FIG. 1 shows an example of the use of a plurality of Beacons 102 in a retail store in which beacons 102 in different locations have been range configured to be short-range or long-range. Long-range Beacons provide overlapping coverage areas. Overlapping coverage of neighboring beacons can be used for example to facilitate synergistic cross-selling in a store.

Thus, in the system, the Beacons 102 can have remotely programmable range attenuation circuitry such that their range can be remotely varied, for example, from a few centimeters to several meters. Thus the Beacons 102 themselves are part of a network, or direct connection, and can be controlled from the computer 202 or independently as shown in FIG. 2. This allows any Beacon 102 to be configured dynamically to be an ultra-short range beacon that can be read only from a device 208 oriented appropriately near it or it can be configured to be a long-range broadcasting beacon that can be read by any device at distance for example a Mobile Device passing casually by. This method of programmable range control of a Beacon can, for example, be used to configure a Bluetooth Low Energy (BLE) Beacon to have an ultra-short range of a few centimeters such that it has to be “scanned” by a computing device 208 in order to be read; or the same BLE Beacon could be dynamically programmed to have a range of several meters to broadcast information within a certain zone around it. This is useful for example when not all computing devices 208 have short-range device readers (such as NFC) and only have long-range readers for devices such as BLE—in which case BLE Beacons could be programmed to be ultra-short range and be used in-lieu of NFC Beacons.

The Beacons 102, for example, can be configured to not transmit any other data to and from the computing devices 208 besides the location information encoded in the Beacon namespace. Then the Beacons 102 can be built as functionality stripped down devices and can be devices that can stay alive on battery power for many years.

Returning to FIG. 1, this figure shows an example of a beacon system 200 implementation for a typical retail store showing how their coverage areas may be adjusted by adjusting their signal strengths. Coverage may overlap neighboring beacon coverage to facilitate synergistic cross-selling or other applications. Several beacons may be needed in each section to identify local groups of products such as:

“Store Level Beacon”: Covers the entire store for Store identification.

“Produce Beacon”: Covers the Produce area.

“Bakery & Deli Level Beacon”: Covers the Bakery & Deli area.

“Meat & Seafood Beacons”: Covers the Meat & Seafood area.

“Dairy Beacon”: Covers the Dairy area.

“Pharmacy Beacon”: Covers the Pharmacy area.

“Liquor Area Beacon”: Covers the Wine & Liquor sections.

“Bank Beacon”: Covers the Bank/ATM area.

“Coffee Shop Beacon”: Covers the in-store Coffee Shop and the surrounding seating areas.

“Checkout Lane Beacons”: Cover each of the checkout lanes and the overlapping end-cap areas.

“Aisle Level Beacons” (shown as A-X and 1-8): Several beacons in each aisle are installed that cover groupings or categories of products both on the left and right sides of each aisle.

Returning to FIG. 2, the figure shows Beacons 4,5,6,7 mounted on the network 204 for remote range configuration of the Beacon 102 by the computer 202. When a Beacon 4 is programmed for short-range interaction, client device/computing device 208 may be held on the order of a few centimeters or less near the Beacon 4 in order to be able to read it. This prevents transmissions from several neighboring Beacons to overlap with the client device. When a Beacon 5,6,7 is programmed for long-range interaction, the client device 9 can read it from several meters away. In the long-range configuration, overlap of neighboring Beacon transmissions may be allowed or it may be prevented by time sequencing the transmission from neighboring Beacons under server control. Thus, as shown in this figure, the server 1 can instruct Beacon 5 to transmit at a given time, Beacon 6 at a different time and Beacon 7 at yet another time to avoid overlapped reading by a client device 9.

The beacon manager 300 shown in FIG. 3 may manage and configure each beacon 102 including the range of each beacon. The beacon manager 300 may also time sequence transmissions of the beacons 102 as described above. The beacon command generator 302 may then generate the data messages (with configurations) for each of the beacons 102. In some embodiments, the layout of the area, such as shown in FIG. 1, may be known and the beacon manager 300 may configure each of the beacons 102 in the area (including the range of the beacon) based on the layout of the area. Thus, the beacon manager 300 may receive the layout of the area including a location of each beacon in the area and a region in the area being managed by each beacon. The beacon manager 300 may then generate a configuration for each beacon in the area (including a range configuration) based on the layout of the area and communicate the configuration to each beacon in the area. Alternatively, if a layout of the deployment site is not known, the beacons 102 may be preconfigured and labeled at the factory to be “CallOut”. “Informational” or “LocationMarking” and the deployment personnel may then deploy the suitable pre-configured beacon at the suitable location at the deployment site.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. An apparatus, comprising:
a plurality of beacons situated in an area, wherein each beacon is situated in a region within the area;
a beacon manager, coupled to each of the plurality of beacons, that determines a configuration for the plurality of beacons based on the region in which the plurality of beacons are situated, wherein the configuration for each beacon includes a range of the beacon selected from a first range and a second range; and
each beacon receives the configuration from the beacon manager for the beacon so that each beacon has a range configured for the region within the area in which the beacon is situated.

2. The apparatus of claim 1, wherein the configuration for each beacon includes a time period during which the beacon transmits its beacon message.

3. The apparatus of claim 2, wherein the beacon manager generates a configuration for a plurality of beacons, wherein the configuration for each beacon has a different time period during which the beacon transmits its beacon message so that the beacon messages of the plurality of beacons are time sequenced.

4. The apparatus of claim 1 further comprising at least one computing device that is capable of communicating with the plurality of beacons, wherein each beacon generates a broadcast message that is receivable by at least one computing device that is in range of a particular beacon.

5. The apparatus of claim 1, wherein the area is one of a building, outdoors or on a mobile platform.

6. The apparatus of claim 1, wherein an SSID of a beacon is segmented and is used to provide location identification of the beacon.

7. The apparatus of claim 1, wherein at least one of the plurality of beacons is a BLE beacon programmed with an short range that is used instead of an NFC beacon.

8. A method for configuring beacons, comprising:
receiving a layout of an area including a location of each beacon in the area and a region in the area for each beacon, the area having a plurality of beacons;
generating, for each beacon, a configuration of the beacon based on the location of the beacon in the area indicated by the layout of the area, the configuration of the beacon including a range of the beacon, wherein the plurality of beacons have different configured ranges; and
communicating, to each beacon, the configuration of the beacon so that the plurality of beacons in the area have overlapping ranges.

9. The method of claim 8, wherein the configuration for each beacon includes a time period during which the beacon transmits its beacon message.

10. The method of claim 9, wherein generating the configuration for each beacon further comprises generating a configuration for a plurality of beacons, wherein the configuration for each beacon has a different time period during which the beacon transmits its beacon message so that the beacon messages of the plurality of beacons are time sequenced.

11. The method of claim 8, wherein the area is one of a building, outdoors or on a mobile platform.

12. The method of claim 8, wherein generating the configuration further comprises segmenting an SSID of the beacon to provide location identification of the beacon.

13. A method for configuring beacons, comprising:
receiving a plurality beacons;
generating, for each beacon, a configuration of the beacon based on a preconfigured use profile of the beacon, the configuration of the beacon including a range of the beacon, wherein the plurality of beacons have different configured ranges;
configuring each of the plurality of beacons based on the preconfigured use profile of each beacon; and
installing the plurality of beacons in an area having a plurality of regions within the area, wherein each beacon is installed in a particular region of the area based on the preconfigured use profile of the beacon.

14. The method of claim 13, wherein the configuration for each beacon includes a time period during which the beacon transmits its beacon message.

15. The method of claim 14, wherein generating the configuration for each beacon further comprises generating a configuration for a plurality of beacons, wherein the configuration for each beacon has a different time period during which the beacon transmits its beacon message so that the beacon messages of the plurality of beacons are time sequenced.

16. The method of claim 13, wherein the area is one of a building, outdoors or on a mobile platform.

17. The method of claim 13, wherein the preconfigured use profile is one of a callout profile, an informational profile and a location marking profile.

18. The method of claim 13, wherein configuring the beacon further comprises segmenting an SSID of the beacon to provide location identification of the beacon.
